(19) United States
(12) Patent Application Publication
(10) Pub. No.: US 2002/0097573 A1
(43) Pub. Date: Jul. 25, 2002

(54) Wiring arrangement for christmas lamp string

(76) Inventor: Wei Hong Shen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/766,622

(22) Filed: Jan. 23, 2001

(51) Int. Cl. F21S 6/00

(52) U.S. Cl. 362/123; 362/249

(57) ABSTRACT

A wiring arrangement for a Christmas lamp string comprises hollow tube with slit longitudinally extended through all or partial length of the tube. The conductive wires can be arranged in the tube through the slit such that no wire is wrapped around the tube to provide tidy appearance. The distal end of the wire has terminal stage for mounting of LED to provide fast installation.

### FIELD OF THE INVENTION

The present invention relates to a wiring arrangement for a Christmas lamp string, especially to a wiring arrangement for a Christmas lamp string wherein the conductive wire is received within a tube with a slit to provide integral appearance of the Christmas lamp string and reduce assembling effort.

### BACKGROUND OF THE INVENTION

The conventional decorative Christmas tree is generally provided with lamp string for ornament. The lamp string 10a comprises a plurality of lamps connected by at least one conductive wire as shown in FIG. 1. However, the lamp string 10a is separated with the tree 11a such that the conductive wire is often inordinately wrapped on the tree 11. For a larger tree, many conductive wires are required; for a smaller tree, the conductive wire influences the appearance of the Christmas tree. Moreover, the lamp often uses bulb of easy failure, generally ⅓ bulbs are broken after a display period.

As shown in FIGS. 2A and 2B, the conductive wire is arranged on the tree by two ways. In the first approach, as shown in FIG. 2A, the wire 20a is wrapped around the trunk 21 a of the tree and located outside the trunk 21 a and stick 22a of the tree. This arrangement is unsightly and hard to assemble. FIG. 2A shows the second arrangement, the wire 20a is tied to a solid trunk 21 a by an automatic wire-bonding machine (not shown). However, the wire 20a has the risk to roll into the automatic wire-bonding machine, the process is difficult. FIGS. 3 and 4 shows a Christmas tree using optical fiber 30a as decorative lamp, wherein light is emitted from end surface of the optical fiber 30a. However, the optical fiber 30a is also manually wrapped on the stick 31 of the Christmas tree. Moreover, the variation of the light from the optical fiber 30a is achieved by using a halogen light source wherein a color filter 33a is rotated by a motor 32a to change the color of the light emitted from the halogen light source. The color change is dull and the assembling thereof is also difficult. As shown in FIG. 4, the Christmas tree using optical fiber comprises a motor 32a, a color filter 33a, a transformer 34a, and an MR-16 light source 35a on bottom of the tree. The components are complicated and the MR-16 light source 35a generates reach a high working temperature of 115° C.

To sum up, the above-mentioned Christmas trees have following drawbacks:

1. The wire is exposed to degrade the appearance of the tree.

2. The bulb has high failure rate.

3. The use of auto wire-bonding machine is not convenient.

4. The use of optical fiber has cumbersome assembling and high cost.

### SUMMARY OF THE INVENTION

It is an object of the present invention to provide a wiring arrangement for a Christmas lamp string comprising hollow tube with slit longitudinally extended through all or partial length of the tube. The conductive wires can be arranged in the tube through the slit such that no wire is wrapped around the tube to provide tidy appearance.

It is another object of the present invention to provide a wiring arrangement for a Christmas lamp string wherein the distal end of the wire has terminal stage for mounting of LED to provide fast installation.

To achieve the above object, the present invention provides a wiring arrangement for a Christmas lamp string comprising a trunk and a plurality of sticks. The trunk is an all-through type rigid tube and houses a wiring set therein; and the wiring set comprises a plurality of conductive wires of different length. A plurality of stick sockets are arranged on outer surface of the trunk with predetermined separation. Each stick is a semi-through type rigid tube and houses a plurality of conductive wires. A plurality of leaves are arranged on outer circumference of the semi-through type rigid tube with predetermined separation. The plurality of sticks are inserted into the stick sockets.

The various objects and advantages of the present invention will be more readily understood from the following detailed description when read in conjunction with the appended drawing, in which:

### BRIEF DESCRIPTION OF DRAWING

FIG. 1 shows prior art Christmas tree;

FIG. 2A is a first kind of wiring method for prior art Christmas tree;

FIG. 2B is a second kind of wiring method for prior art Christmas tree;

FIG. 3 shows prior art Christmas tree with optical fiber;

FIG. 4 shows the optical elements in the prior art Christmas tree with optical fiber;

FIG. 5 shows the stick structure in the wiring arrangement for a Christmas lamp string according to the present invention;

FIG. 6 shows the exploded view of the Christmas lamp string according to the present invention;

FIG. 7A shows the wiring set of the present invention;

FIG. 7B shows the stick socket of the present invention;

FIG. 8 is the perspective view of the Christmas lamp string according to the present invention; and

FIG. 8A shows the perspective view of the sleeve of the present invention.

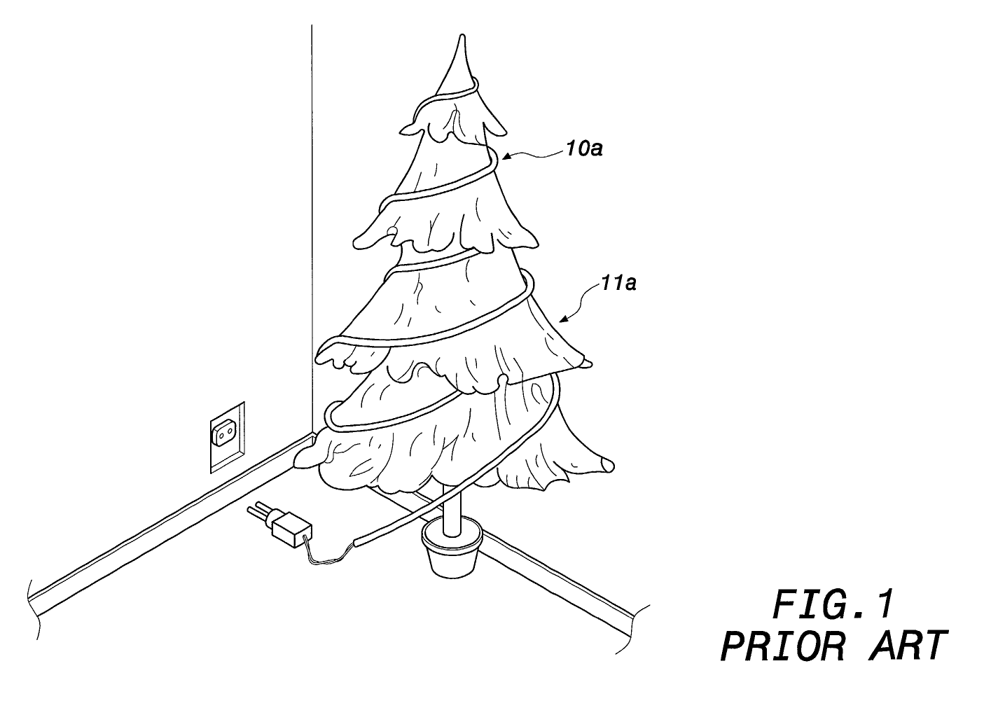

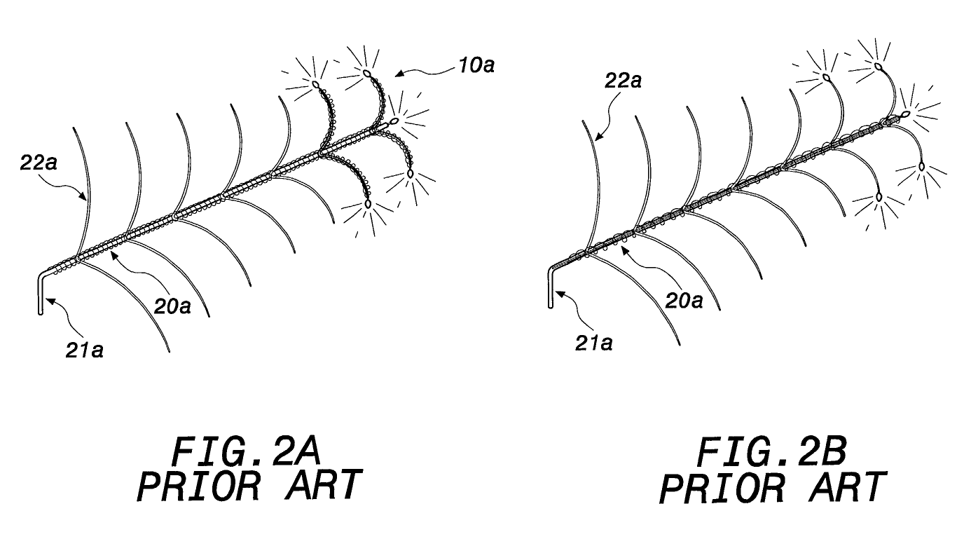

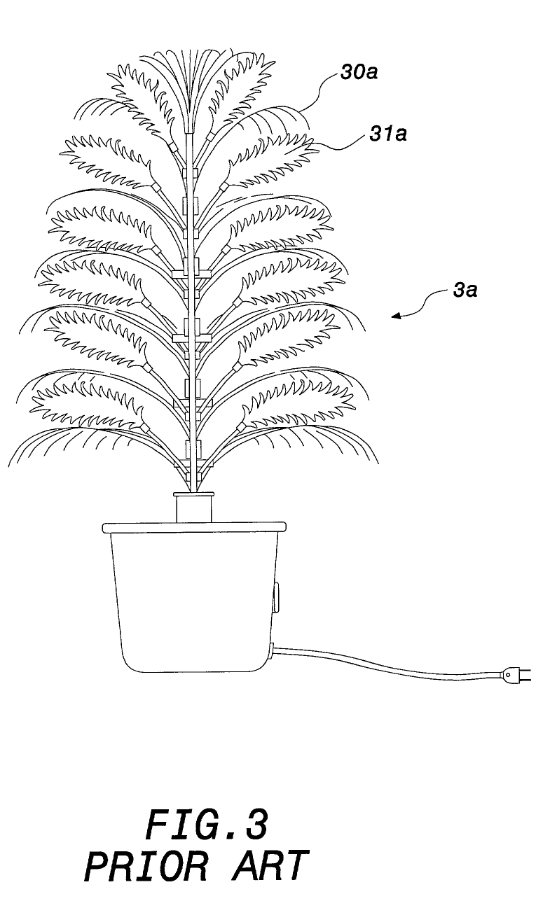

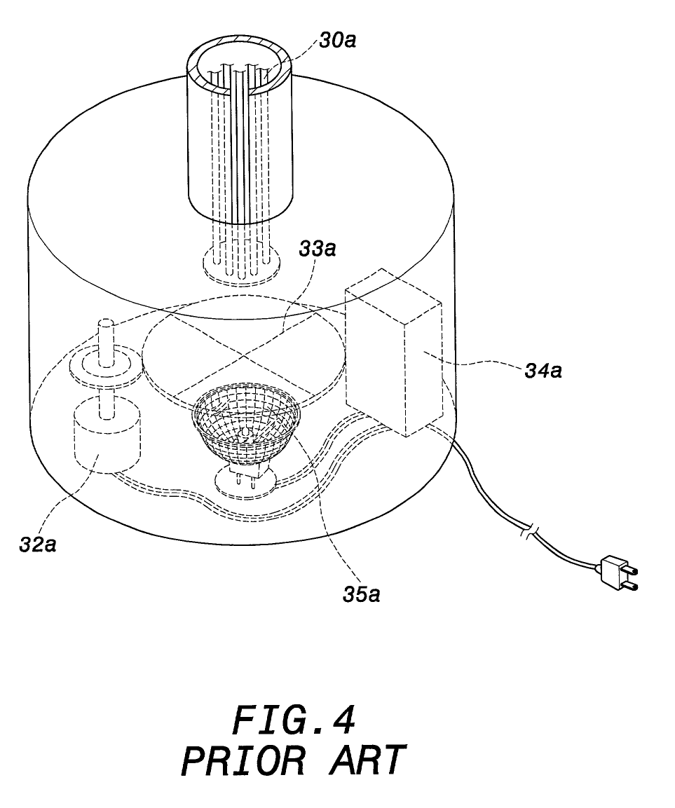

### DETAILED DESCRIPTION OF THE INVENTION

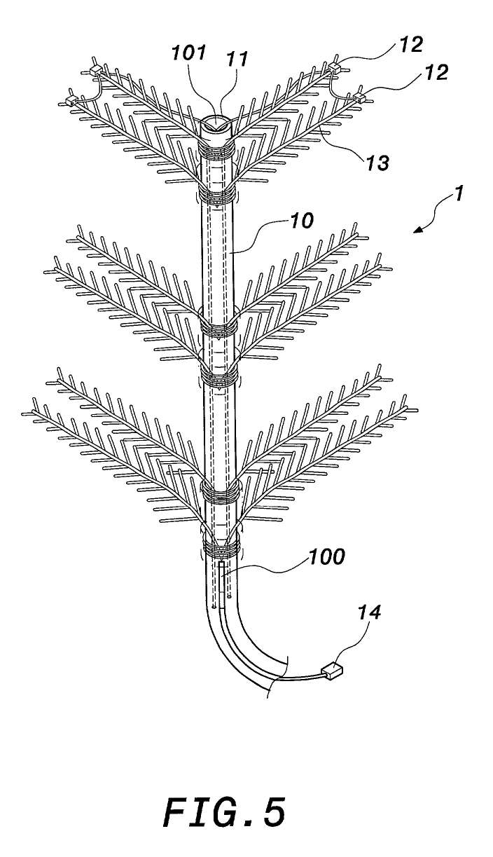

FIG. 5 shows the tree structure of a Christmas tree using the wiring arrangement according to the present invention. The stick 1 comprises a semi-through type rigid tube 10, a plurality of conductive wires 11, a plurality of terminal stages 12 and a plurality of leaves 13.

The semi-through type rigid tube 10 has one bent end and a slit 100 on the bent end. The plurality of conductive wires 11 pass through the slit 100 and extend to an upper opening 101 of the rigid tube 10 through space within the tube 10. The plurality of terminal stages 12 are connected on one distal ends of the conductive wires 11 and a plurality of LED (not shown) are assembled to the f terminal stages 12. Moreover, a plurality of terminal stages 14 are connected on another distal ends of the conductive wires 11. The plurality of leaves 13 are arranged on outer circumference of the semi-through type rigid tube 10 with predetermined separation and are tied to the tube 10 by an automatic wire-bonding machine (not shown).

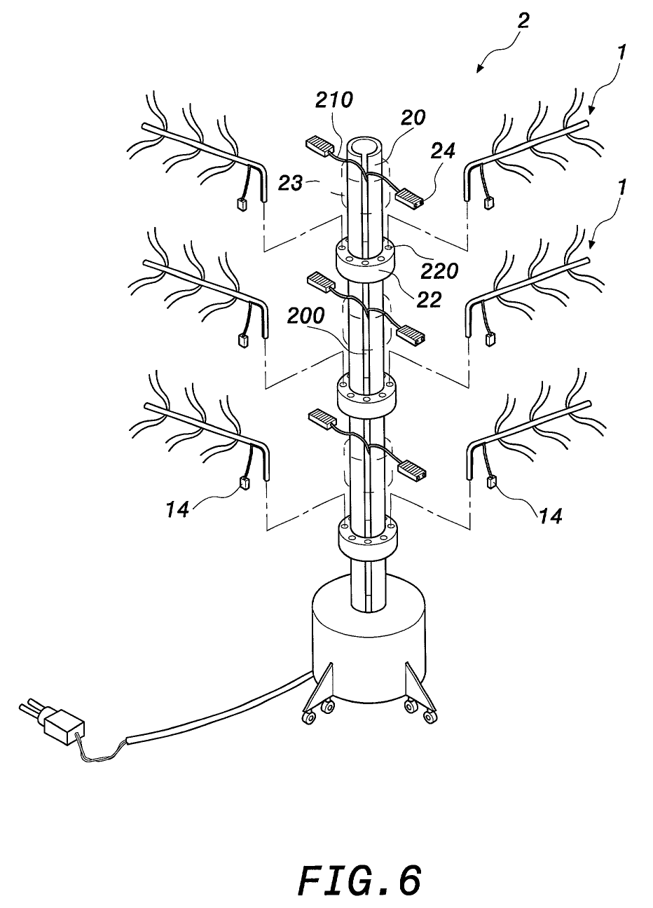

FIGS. 6 to 8 shows the exploded view and perspective view of the present invention. The wiring arrangement comprises a trunk 2 and a plurality of sticks 1.

The trunk 2 comprises an all-through type rigid tube 20, a wiring set 21 and a plurality of stick sockets 22.

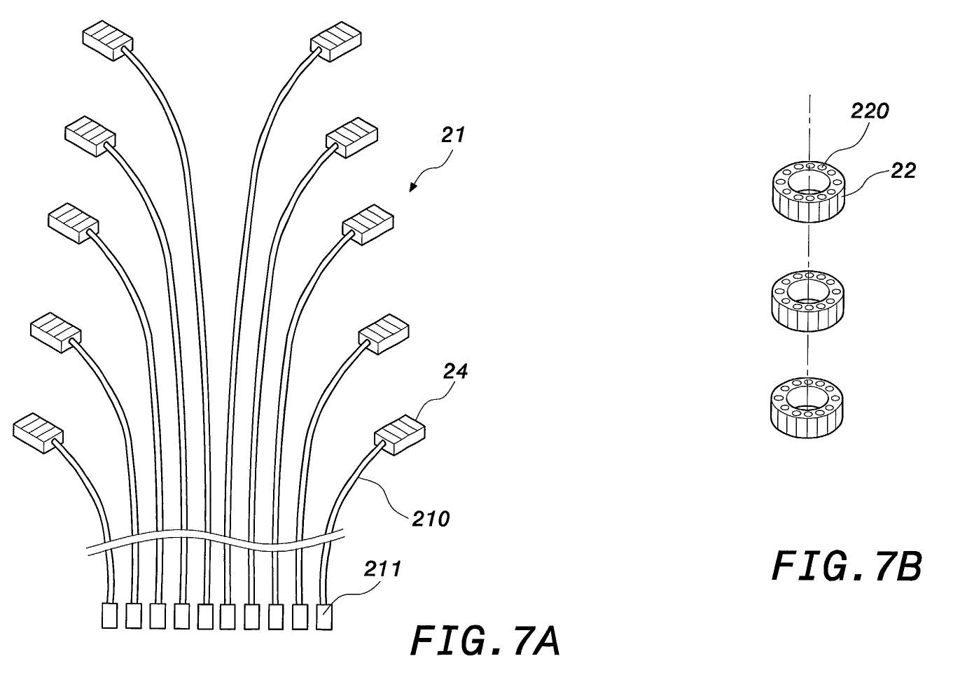

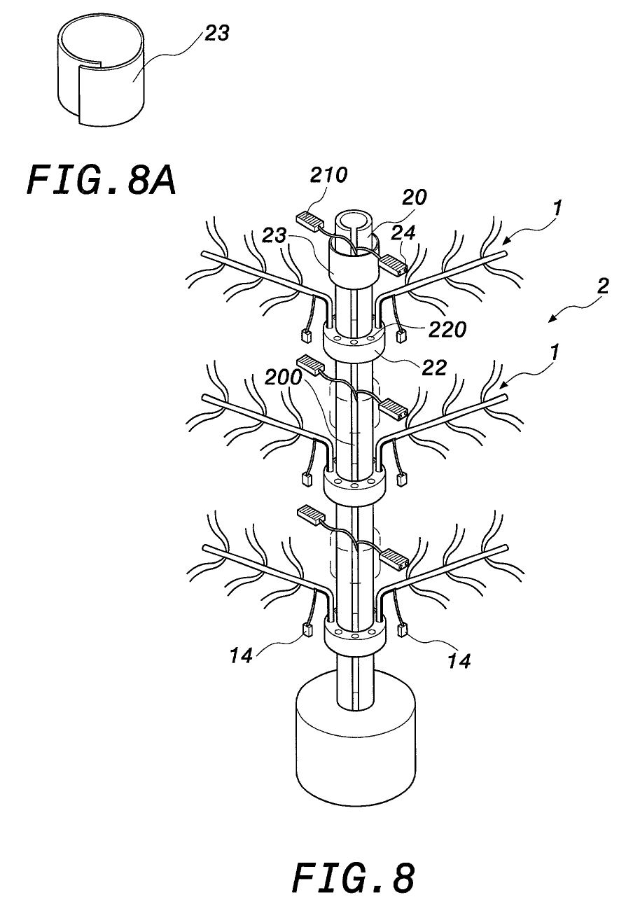

The all-through type rigid tube 20 is a hollow tube 20 having a slit 200 longitudinally extended through all length of the tube 20. By provision of the slit 200 on the tube 20, the wiring set 21 can be quickly arranged within the tube 20 as shown in FIG. 7A. The wiring set 21 comprises a plurality of conductive wires 210 of different length. Each conductive wire 210 has a terminal 211 on one end thereof and connected to power means (not shown) and a terminal stage 24 on another end thereof. The terminal stage 24 is used with the terminal stage 14 arranged on the sticks 1. At first, the longer conductive wires 210 are passed through the slit 200 and arranged within the tube 20. At least one flexible sleeve 23 (for example, made of PVC materials) is arranged around the tube 20 to shield the exposed portions of the conductive wires 210, as shown in FIG. 8A. Therefore, the conductive wires 210 can be retained within the tube 20 and the terminal stages 24 are also clamped to specific positions. Afterward, the stick sockets 22 are assembled to the tube 20 from the bottom part of the tube 20 and in raising order. As shown in FIG. 7B, the stick socket 22 is a ring with a plurality of through holes 220 vertically through the stick socket 22. One end of the stick 1 is inserted into the hole 220 to form a tree structure. When the power is on, the LED is lightened (not shown).

Moreover, the wiring arrangement can also adapt flexible tube to provide loop or other configuration used for vines or wreath.

To sum up, the wiring arrangement according to the present invention has following advantages:

1. The wiring arrangement has a tube with slit longitudinally extended through all length of the tube; the installation of wire is easy.

2. The wire is hidden within the tube; the automatic wire-bonding machine can be safely used.

3. The problem of unsightly problem caused by the wrapped wire is solved.

4. The use of terminal stage allows fast installation of LED.

5. The use of LED reduces cost of the Christmas trees.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A wiring arrangement for a Christmas lamp string, comprising
a trunk being an all-through type rigid tube and housing a wiring set therein; the wiring set comprising a plurality of conductive wires of different length; a plurality of stick sockets arranged on outer surface of the trunk with predetermined separation; and
a plurality of sticks, each being a semi-through type rigid tube and housing a plurality of conductive wires; a plurality of leaves arranged on outer circumference of the semi-through type rigid tube with predetermined separation; the plurality of sticks being inserted into the stick sockets.

2. The wiring arrangement for a Christmas lamp string as in claim 1, wherein the wiring arrangement is used for vines or wreath and being all-through type flexible tube.

3. The wiring arrangement for a Christmas lamp string as in claim 1, wherein a flexible sleeve is arranged around the trunk and between adjacent stick sockets.

4. The wiring arrangement for a Christmas lamp string as in claim 1, wherein one distal end of the conductive wire in the trunk has a terminal stage; the terminal stage connected to a terminal stage on one end of the conductive wire in the stick; another distal end of the conductive wire in the trunk having a terminal stage on which a plurality of LED are mounted.

5. The wiring arrangement for a Christmas lamp string as in claim 1, wherein the trick socket is of ring shape with a plurality of holes vertical through the ring.
